(19) United States
(12) Patent Application Publication
(10) Pub. No.: US 2015/0119218 A1
(43) Pub. Date: Apr. 30, 2015

(54) SYSTEMS WITH PRE-HEATERS FOR PRODUCING SEAMED ENCASED PRODUCTS AND RELATED DEVICES, METHODS AND COMPUTER PROGRAM PRODUCTS

(71) Applicant: Tipper Tie, Inc., Apex, NC (US)

(72) Inventors: Thomas E. Whittlesey, Durham, NC (US); Brent Stallings, Raleigh, NC (US)

(21) Appl. No.: 14/521,905

(22) Filed: Oct. 23, 2014

Related U.S. Application Data
(60) Provisional application No. 61/897,976, filed on Oct. 31, 2013.

(51) Int. Cl. B31B 19/26

(52) U.S. Cl. CPC B31B 19/26
USPC 493/269

(57) ABSTRACT

Methods, computer program products and apparatus for producing encased products using one or more pre-heaters residing proximate to but downstream of a heat-seal heater to pre-heat at least one long edge portion of a casing, typically the long edge portion associated with a lower layer of a joint to be sealed.

### RELATED APPLICATIONS

This application claims the benefit of and priority to U.S. Provisional Application Ser. No. 61/897,976, filed Oct. 31, 2013, the contents of which are hereby incorporated by reference as if recited in full herein.

### FIELD OF THE INVENTION

The present invention relates to packaging systems that use flat roll stock.

### BACKGROUND OF THE INVENTION

Conventionally, in the production of consumer goods such as, for example, meat or other food products, such products are fed (typically pumped) or stuffed into a casing in a manner that allows the casing to fill with a desired amount of the product. One type of casing is a heat-sealed tubular casing formed by sealing a thin sheet of flexible material, typically elastomeric material, together. U.S. Pat. Nos. 5,085,036 and 5,203,760 describe examples of automated, high-speed contact sealing apparatus forming flat roll stock into tubular casings. The contents of these patents are hereby incorporated by reference as if recited in full herein.

### SUMMARY OF EMBODIMENTS OF THE INVENTION

Embodiments of the present invention provide apparatus, systems, devices, methods and computer program products configured to pre-heat at least a target region of a casing in situ as the casing is pulled into and/or through a forming collar to a temperature above ambient and below a melt point temperature of the casing.

The target region can include or be solely an upper surface of a long edge of a lower layer of a seam of the casing.

The casing can be a multi-layer film comprising at least two different materials.

The pre-heating can include directing a heat source toward a single long side edge of casing at a location on or proximate the forming collar a distance of between about 1-4 inches from a heat band seal assembly.

Embodiments of the invention are directed to methods for sealing flat roll stock into shaped casing for encasing target products. The methods include: pulling casing from a roll of flat stock through a forming collar to form a shaped casing; pre-heating the casing as the casing travels through the forming collar; and sealing long edge portions of the casing together after the pre-heating.

The pre-heating can be carried out so that one or both long edge portions of the casing has an elevated temperature that is under a melt point of the casing but within about 25 degrees F. of the melt point as the casing approaches or resides under or over a heat seal band for the sealing.

The pre-heating can include pre-heating at least one long edge portion of the casing as it travels over a shoulder associated with the forming collar within about 0.1 second to about 1 second prior to applying a heat seal band heater to carry out the sealing.

The pre-heating can include locally heating only one or only both of the long edge portions of the casing as the casing travels over outer shoulders of the forming collar.

The pre-heating can include heating a single long edge portion of the casing as the casing resides on a corresponding single shoulder of the forming collar:

The pre-heating can include pre-heating a target region or regions of the casing associated with one or both long edge portions of the casing so that one or both of the long edge portions have a temperature below a melt point but within about 25 degrees F. of the melt point measured when the casing exits the forming collar in a tubular shape or when the casing is under a heat-seal heater.

The method may include automatically extending a pre-heater to reside above and proximate the forming collar to carry out at least some of the pre-heating.

The formed shaped casing can be tubular shaped casing. The method can include applying at least one clip to a trailing and/or leading end portion(s) of the sealed casing.

The sealing can be carried out using a rotating or stationary heat-band seal heater within about 0.1 second to about 1 second after the pre-heating raises a temperature of a lower layer of a joint of the casing to within about 25 degrees F. of, but below, a melting point of the casing.

The pre-heating can be carried out using a plurality of spaced apart pre-heaters. At least one of pre-heaters can be positioned above the forming collar so that at least a lower end thereof is laterally offset from an axially extending centerline of a horn extending through the forming collar.

The pre-heating can be carried out using a single pre-heater positioned above the forming collar. The method can include electronically translating the single pre-heater from a home position to a lowered heating position proximate a shoulder of the forming collar, so that at least a lower end of the pre-heater is laterally offset from an axially extending centerline of a horn extending through the forming collar.

The pre-heating can include directing a heat source toward a single long side edge portion of the casing at a location above the forming collar a distance of between about 1-4 inches axially away from a rearward end of a heat band seal assembly.

Other embodiments are directed to apparatus for forming shaped casings from flat roll stock for encasing products therein.

The apparatus can include: a housing; a forming collar residing in the housing, the forming collar configured to cooperate with a roll of flat casing material to force the flat casing material to take on a shape with long edge portions of the casing material residing proximate each other; and at least one pre-heater held in the housing, at least one of which resides on or proximate the forming collar.

The apparatus can include a heat-seal heater held in the housing a distance in front of the forming collar. The at least one pre-heater can be configured to heat the casing material so that at least one of the long edge portions has an elevated temperature that is under a melt point of the casing material but within about 25 degrees F. of the melting point as the casing material approaches or moves under or over the heat seal heater.

The at least one pre-heater can include at least one pre-heater sized and configured to direct heat toward one shoulder or both shoulders of the forming collar to pre-heat at least one long edge portion of the casing material as the casing material travels over a respective shoulder associated with the forming collar.

The at least one pre-heater directed toward the shoulder or shoulders of the forming collar can be configured to pre-heat one or both long edge portions to an elevated temperature that is under a melt point of the casing material but within about 25 degrees F. of the melt point within about 0.1 second to about 1 second prior to when the heat-seal heater contacts the preheated long edge portion or long edge portions to heat seal a joint formed by joining the long edge portions.

The apparatus can include one or more pre-heaters that are configured to locally heat only one or only both of the long edge portions as the casing travels over outer shoulders of the forming collar.

The at least one pre-heater can be a single pre-heater configured to heat a target localized region on a single long edge portion of the casing over a single shoulder of the forming collar.

The at least one pre-heater can include at least one pre-heater held by a pre-heater assembly. The pre-heater assembly can be configured to hold the at least one pre-heater above the forming collar and automatically translate the at least one pre-heater between home and different operative positions. The different operative positions can position a lower end of the heater at different vertical distances to accommodate different size horns and respective forming collars.

The heat-seal heater can include a rotating heat-seal band and wherein the at least one pre-heater is configured to raise a temperature of a lower layer of a joint of the casing to within about 25 degrees F. of, but below, a melting point of the casing proximate the heat-seal band heater.

At least one of the at least one pre-heaters can be positioned above the forming collar so that a lower end thereof is laterally offset from an axially extending centerline of the horn and directs heat toward an exterior surface of a shoulder of the forming collar.

The at least one pre-heater can reside on or proximate the forming collar comprises a first pre-heater configured to heat a single long side edge portion of the casing at a location above the forming collar a distance of between about 1-4 inches from a rearward end of a heat-seal band of the heat-seal heater.

The at least one pre-heater can include a pre-heater held by the forming collar.

The at least one pre-heater can include a heat gun configured to blow heated compressed gas toward the forming collar.

The apparatus can include at least one temperature sensor in communication with the at least one pre-heater and a controller held by or in communication with the apparatus. The controller can be configured to adjust power to the at least one pre-heater to control a target elevated temperature generated by the at least one pre-heater.

Yet other embodiments are directed to computer program products for operating an apparatus that supplies different casing materials and different horn diameters to provide encased elongate products. The computer program product includes a non-transitory computer readable storage medium having computer readable program code embodied in the medium. The computer-readable program code includes computer readable program code configured to provide a plurality of different predetermined operational modes for an apparatus that releasably mounts different diameter horns and respective different size forming collars to supply different sized tubular casings from flat roll stock; and computer readable program code configured to direct at least one pre-heater to translate between an operative position over a respective forming collar to a home position.

The computer program product also include computer readable program code configured to control heat output of the at least one pre-heater using temperature data from at least one temperature sensor in communication with the pre-heater.

It is noted that any one or more aspects or features described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail in the specification set forth below.

These and other objects and/or aspects of the present invention are explained in detail in the specification set forth below.

### BRIEF DESCRIPTION OF THE DRAWINGS

FIG. 1 is a front perspective view of a packaging machine according to embodiments of the present invention.

FIG. 2 is a front view of the machine shown in FIG. 1.

FIG. 3 is an enlarged side perspective view of a forming collar and pre-heater according to embodiments of the present invention.

FIG. 4 is a schematic lateral section view of a horn and casing material for the packaging machine shown in FIG. 1.

FIG. 5 is an enlarged top perspective view of the forming collar cooperating to form tubular casing shown in FIG. 3 according to embodiments of the present invention.

FIG. 6 is a side perspective view of a portion of the packaging machine shown in FIG. 1.

FIG. 7 is a side perspective view of a pre-heater assembly according to embodiments of the present invention.

FIG. 8 is an exploded view of the pre-heater assembly shown in FIG. 7.

FIG. 9A is a side view of the pre-heater assembly shown in FIGS. 7 and 8.

FIG. 9B is a top section view taken along lines 9B-9B in FIG. 9A.

FIG. 10A is a schematic illustration of a circuit according to embodiments of the present invention.

FIG. 10B is a schematic illustration of a circuit according to embodiments of the present invention.

FIG. 11 is a side partial cutaway view of a packing machine illustrating optional pre-heaters according to some embodiments of the present invention.

FIG. 12 is a side partial cutaway view of a packing machine illustrating an integral pre-heater for a forming collar according to some embodiments of the present invention.

FIG. 13 is a front perspective view of a packaging machine with a pre-heater having a shaped head according to embodiments of the present invention.

FIG. 14A is a front perspective view of a packaging machine with a pre-heater having a curved head according to embodiments of the present invention.

FIG. 14B is a schematic front view of a pre-heater with a curved head according to embodiments of the present invention.

FIG. 15 is a front view of a packaging machine cooperating with or including a clipper according to embodiments of the present invention.

FIG. 16 is a flow chart of operations that may be carried out according to embodiments of the present invention.

FIG. 17 is a block diagram of a data processing system according to embodiments of the present invention.

### DETAILED DESCRIPTION

The present invention will now be described more fully hereinafter with reference to the accompanying figures, in which embodiments of the invention are shown. This invention may, however, be embodied in many different forms and should not be construed as limited to the embodiments set forth herein. Like numbers refer to like elements throughout. In the figures, certain layers, components or features may be exaggerated for clarity, and broken lines illustrate optional features or operations unless specified otherwise. The term “Fig.” (whether in all capital letters or not) is used interchangeably with the word “Figure” as an abbreviation thereof in the specification and drawings. In addition, the sequence of operations (or steps) is not limited to the order presented in the claims unless specifically indicated otherwise.

The term “concurrently” means that the operations are carried out substantially simultaneously.

The term “about” means that the noted value can vary by +/−20%.

It will be understood that when a feature, such as a layer, region or substrate, is referred to as being “on” another feature or element, it can be directly on the other element or intervening elements may also be present. In contrast, when an element is referred to as being “directly on” another feature or element, there are no intervening elements present. It will also be understood that, when a feature or element is referred to as being “connected”, “attached” or “coupled” to another feature or element, it can be directly connected to the other element or intervening elements may be present. In contrast, when a feature or element is referred to as being “directly connected”, “directly attached” or “directly coupled” to another element, there are no intervening elements present. The phrase “in communication with” refers to direct and indirect communication. Although described or shown with respect to one embodiment, the features so described or shown can apply to other embodiments.

The term “circuit” refers to software embodiments or embodiments combining software and hardware aspects, features and/or components, including, for example, at least one processor and software associated therewith embedded therein and/or executable by and/or one or more Application Specific Integrated Circuits (ASICs), for programmatically directing and/or performing certain described actions, operations or method steps. The circuit can reside in one location or multiple locations, it may be integrated into one component or may be distributed, e.g., it may reside entirely in or supported by a cabinet or workstation (e.g., HMI of a machine) or single computer, partially in one workstation, cabinet, or computer, or totally in a remote location away from a local cabinet, processor, computer or workstation. If the latter, a local computer and/or processor can communicate over a LAN, WAN and/or internet to transmit instructions/data between appropriate components.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

The term “frame” means a generally skeletal structure used to support one or more assemblies, modules and/or components. The frame can be a floor mount frame. The term “automated” means that operations can be carried out substantially without manual assistance, typically using programmatically directed control systems and electrical and/or mechanical devices. The term “semi-automatic” means that operator input or assistance may be used but that most operations are carried out automatically using electromechanical devices and programmatically directed control systems.

In the description of embodiments of the present invention that follows, certain terms are employed to refer to the positional relationship of certain structures relative to other structures. As used herein, the term “front” or “forward” and derivatives thereof refer to the general or primary direction that the filler or product travels in a production line to form an encased product; this term is intended to be synonymous with the term “downstream,” which is often used in manufacturing or material flow environments to indicate that certain material traveling or being acted upon is farther along in that process than other material. Conversely, the terms “rearward” and “upstream” and derivatives thereof refer to the directions opposite, respectively, the forward and downstream directions.

The present invention is particularly suitable for producing encased products that may also employ closure clips to seal products held in the casings. The product may be a linked chain of elongated extruded product held in a casing. The casing can be any suitable casing (edible or inedible, natural or synthetic) such as, but not limited to, collagen, cellulose, plastic, elastomeric and/or polymeric casing. Typically, the casing material is elastomeric and/or polymeric planar roll stock. The elastomeric and/or polymeric sheet is a relatively thin sheet (or film) of roll-stock that can be formed in situ into a continuous length of heat-sealed and/or otherwise joined or seamed tubular casing. Embodiments of the invention are configured to seal laminated or multi-layer films. The multi-layer films can comprise different materials, typically one material as a first layer and a second material as an overlying second layer. The different materials can be laminated or one layer can be a coating such as a metalized spray coating. The laminated or multi-layer films can include “foil film”, metalized polymeric and/or elastomeric films, such as aluminized plastic and/or aluminized polymeric films. In some embodiments, the films can comprise heat-shrink films.

The term “film” means the material is thin. The thickness is typically under about 0.5 mm, such as in a range of between about 0.02 mm to about 0.3 mm, typically between about 0.03 mm to about 0.13 mm. In some embodiments, the film can have a thickness that is about 0.03 mm, about 0.04 mm, about 0.05 mm, about 0.06 mm, about 0.07 mm, 0.08 mm, about 0.09 mm, about 0.10 mm, about 0.11 mm, about 0.12 mm, about 0.13 mm, about 0.14 mm, about 0.15 mm, about 0.16 mm, about 0.17 mm, about 0.18 mm, about 0.19 mm, about 0.20 mm, about 0.25 mm, about 0.30 mm and the like. However, the casing can have other thicknesses.

The forming can be carried out substantially automatically and continuously over a desired interval (typically between at least about 45-60 minutes, depending on the size of the length of the roll stock). The sealing can be performed using a heat seal. The seal can seal a seam formed by joining two outer long sides of the casing/film. The seam can be a flat, fin, or other overlapping and/or abutting joint configuration.

The encased elongated or tubular product can be an elongated food product, typically a meat product. Exemplary meat products include, but are not limited to, strands of meat (that may comprise pepperoni, poultry, and/or beef or other desired meat), and processed meat products including whole or partial meat mixtures, including sausages, hotdogs, and the like. Other embodiments of the present invention may be directed to seal other types of food (such as cheese) or other product in casing materials. Examples of other products include pasty products such as caulk or sausage or powders such as granular materials including grain, sugar, sand and the like or other flowable materials including wet pet food (similar to that held conventionally in cans) or other powder, granular, solid, semi-solid or gelatinous materials including explosives. Thus, embodiments of the invention can be used for packaging target products for any industry including food, aquaculture, agriculture, environmental, building or home maintenance supplies, chemical, explosives, or other applications.

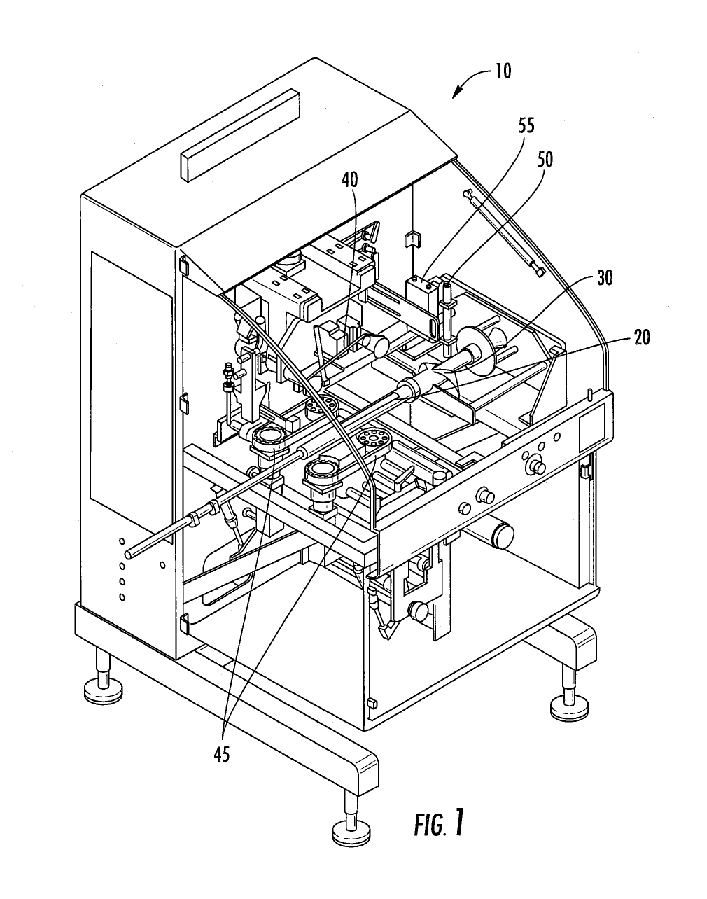

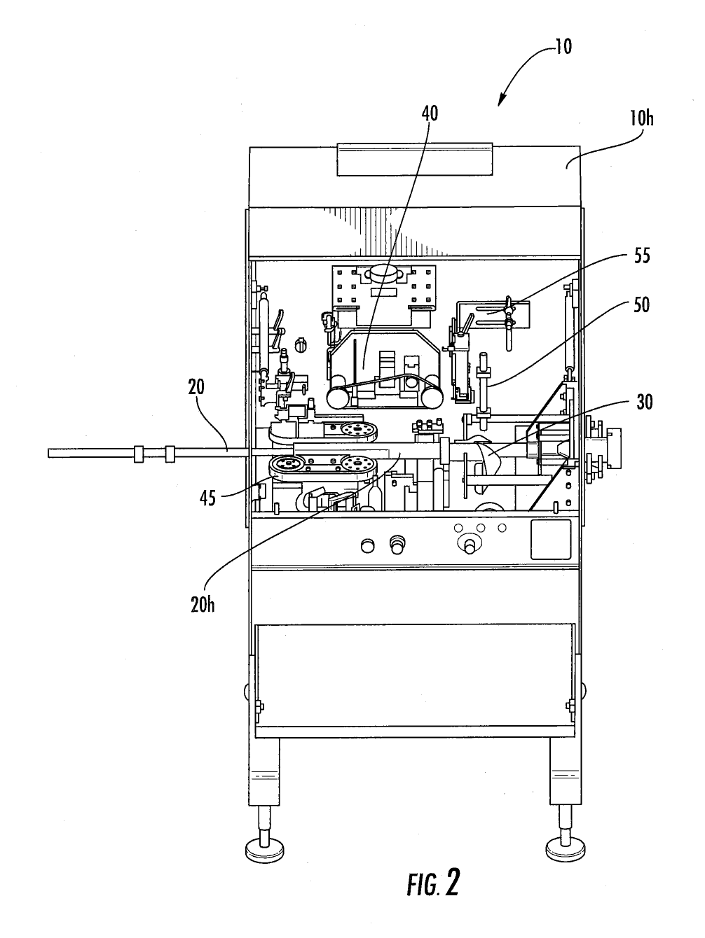

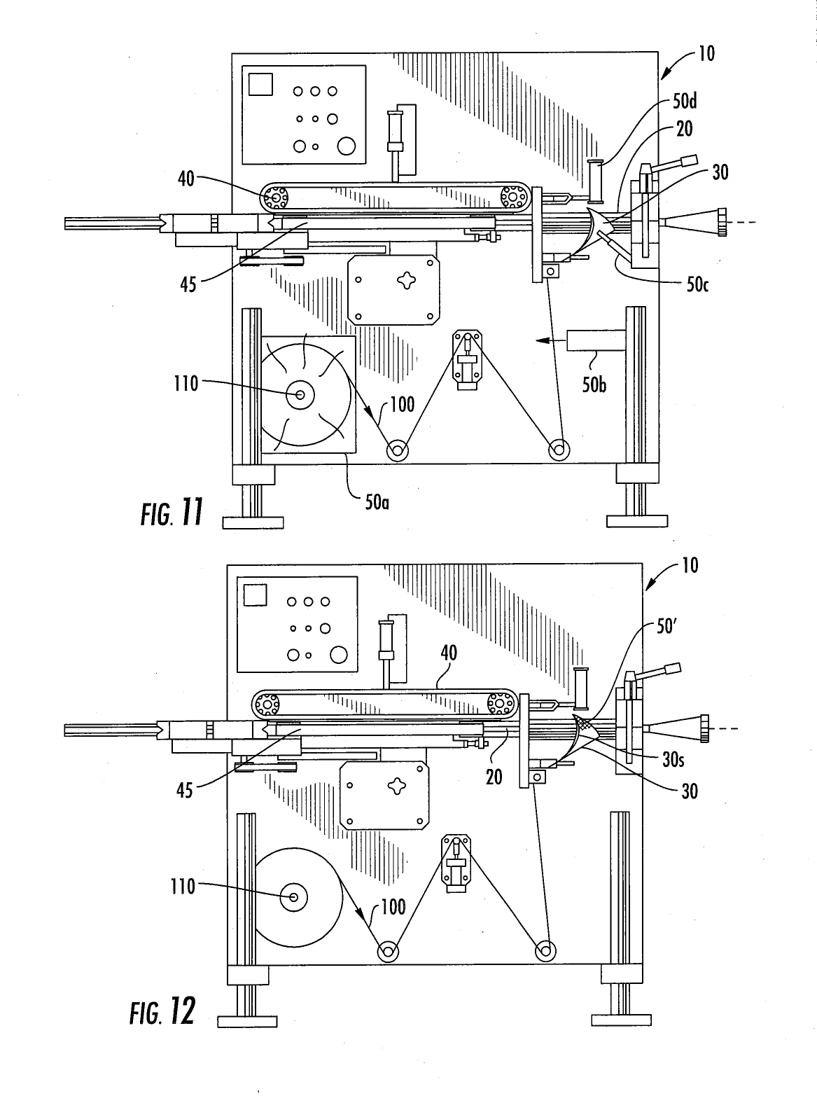

Turning now to FIGS. 1 and 2, an exemplary packaging apparatus 10 configured to form seamed tubular casings is shown. The apparatus 10 includes a horn 20, a forming collar 30, a heat-seal assembly 40 (also called a “heat-seal heater”), a film drive assembly 45 and at least one pre-heater 50. The film drive assembly 45 can optionally include vacuum drives with belts that contact opposing sides of the casing on the horn 20 to pull the casing forward. However, other film drive assemblies can be used. The film drive assembly 45 can be configured to operate with an adjustable drive speed to pull flat stock casing/film 100 from a roll of flat casing 110 (FIG. 11). The term “film drive assembly” and derivatives thereof means the drive system for driving any casing material and is not limited to driving “film”.

While the figures illustrate a heat-seal heater 40 for forming the seal on the casing, it is also contemplated that other sealing assemblies can be used rather than or with the heat-seal heaters, including, for example, adhesive (heated) or tape seal systems as is known to those of skill in the art. Also, while shown with respect to a single clipper system, the packaging system can be a multi-clipper system. See, e.g., U.S. Pat. No. 8,006,463, the contents of which are hereby incorporated by reference as if recited in full herein.

The drive speed can be such that the casing is advanced over the forming collar 30 and through the heat-seal heater 40 at a desired speed. The speed can vary depending on machine, drive systems, casing and products. The speed may be between about 20 ft/min to about 400 ft/min, but other speeds may be possible. For some particular embodiments, the speed may typically between about 20-300 ft/min, more typically between about 20 ft/min to about 150 ft/min. In the upper end of this range, the long ends of the casing 100u, 100b are typically under the heat-seal heater 40 for a short time of between about 0.1 second to about 0.5 seconds. For example, at a rate that is about 150 ft/min, the exposure to the heat-seal heater 40 can be, for example, about 0.2 seconds.

In some embodiments, the heat-seal assembly 40 can comprise a heat-band heater that uses a continuously rotating (endless) heat seal-band to seal the seam. U.S. Pat. Nos. 5,085,036 and 5,203,760 describe examples of automated, high-speed contact sealing apparatus forming flat roll stock into tubular film casings. The contents of these patents are hereby incorporated by reference as if recited in full herein. Embodiments of the invention employ one or more pre-heaters 50 to facilitate a reliable, consistent seal by the heat-seal heater 40. The pre-heater(s) 50 may also allow a faster heat-band seal speed or shorter heat-band seal length.

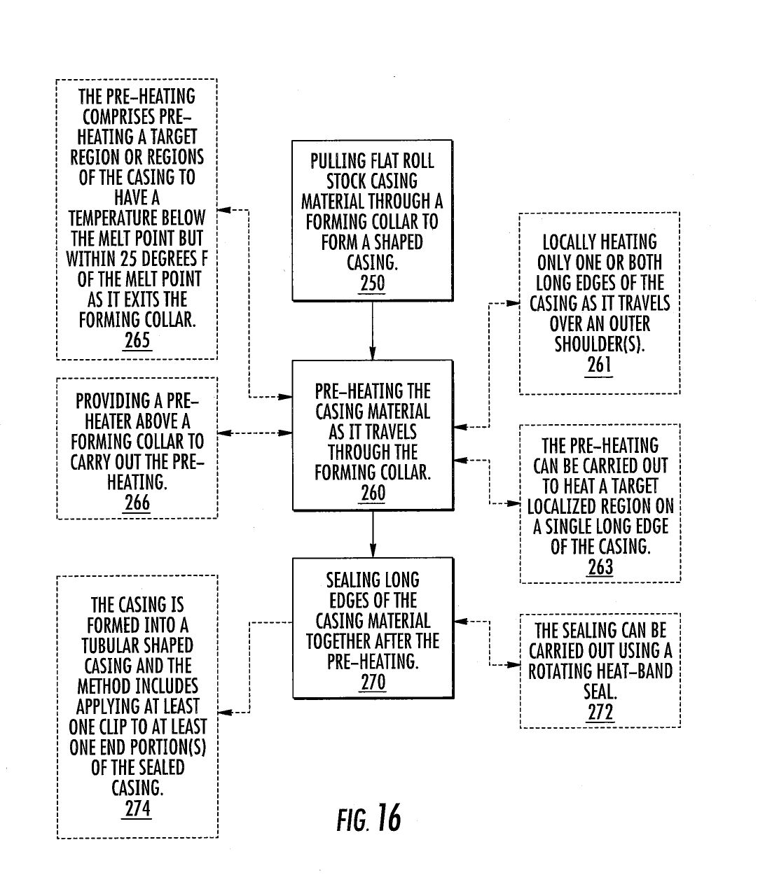

It is contemplated that other heat-seal heater configurations or assemblies may be used. For example, adhesive seals can be used with heat-seal assistance. The heat-seal heater 40 can comprise rollers or other contact-based seal mechanisms. Thus, although the at least one pre-heater 50 is shown with respect to a heat band seal 40, it is contemplated that the at least one pre-heater 50 may be suitable for use with other packaging machines, including adhesive, and roller type contact systems, for example. Also, although particularly suitable for tubular casings with long edge seals and clips on ends thereof (FIG. 15), the at least one pre-heater 50 may be used to facilitate seals on bags formed from flat sheet stock.

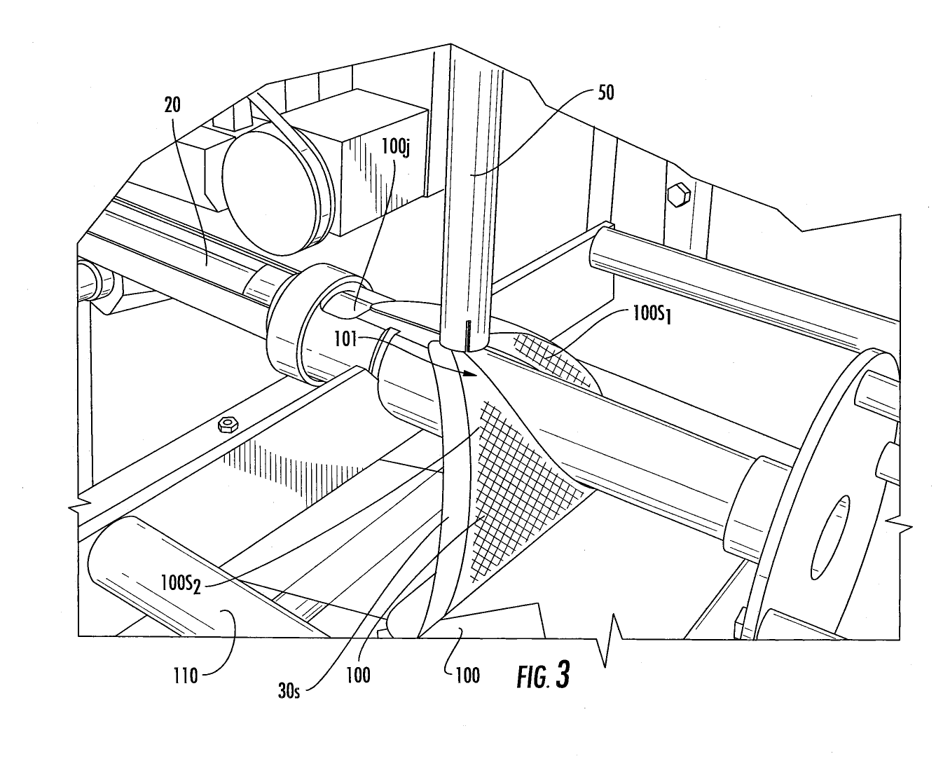

As shown in FIG. 3, the at least one pre-heater 50 typically includes at least one pre-heater 50 that resides on, about or proximate the forming collar 30 to pre-heat at least a target region 101 of a casing in situ as the casing 100 is pulled into and/or through the forming collar 30 to a temperature above ambient and below a melt point temperature of the casing 100.

As shown in FIG. 3, for example, the at least one pre-heater 50 can include a heater that is aligned and targeted to a localized part of the casing along the long edges forming the seal. In some embodiments, the pre-heater 50 can be configured to pre-heat the target region 101 before the upper layer 100u overlaps the bottom layer 100b as the formed tubular casing exits the forming collar 30 adjacent the heat-seal heater 40.

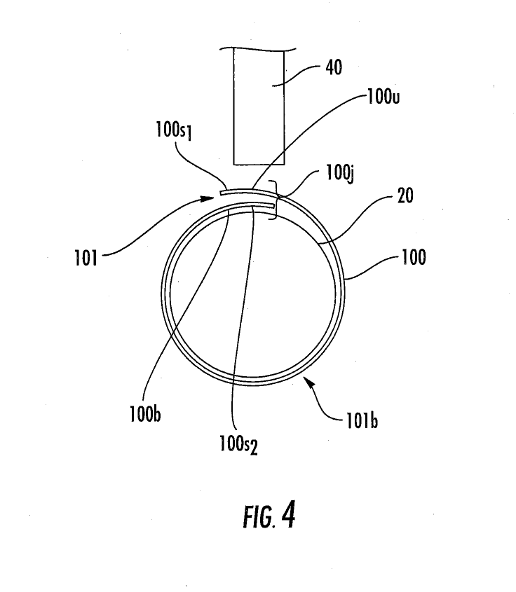

The target region 101 can reside along a long side or edge portion 101s₂ shown as a left side in FIGS. 3 and 5. As shown in FIG. 4, this side 101s₂ can form a lower layer 100b of casing which resides under an upper layer of casing 100u formed by the other outer side portion 100s₁ in front of the heat seal heater 40 to form a heat-seal seam or joint 100j of the casing 100. Thus, the pre-heater 50 can heat the target region of casing 101 to a defined temperature or within a desired temperature range that is above ambient temperature of the packaging facility and under a melting point of the casing. At least one pre-heater 50 can be aligned with a respective shoulder 30s of the forming collar.

In some embodiments, the pre-heater 50 proximate the horn 30, acting alone or with other pre-heaters (see, e.g., FIG. 11), is configured to heat the casing 100 so that the target region 101 is within a defined range of the melting point of the casing.

It is contemplated that the range may be within about 5-25 degrees F. of the melting point of the casing but other ranges are possible and may vary with casing material and machine components such as the heat-seal and/or film drive speed for example.

Increasing the temperature of the casing 100 along at least a long edge of a lower layer 100b forming part of the heat-seal joint 100j so that it has an elevated temperature proximate the heat seal heater 40 can reduce the amount of work/heating that needs to be applied by the heat-seal heater which can increase sealing speed at the heat-seal heater 40 and/or provide a more reliable seal for the casing.

More than one pre-heater 50 can be used to heat only one long side 100s₂. In some embodiments, one or more pre-heaters 50 can be configured to pre-heat both long sides 100s₁, 100s₂. Where the apparatus 10 includes pre-heaters 50 to heat both long sides, they can heat the respective target casing segments to different temperatures or substantially the same temperature. The pre-heaters 50 can be configured for localized heating of one or both long sides (e.g., long edges) to avoid heating the bottom of the tubular casing to an elevated temperature (but some heating may optionally occur). The primary body 101b of the casing away from the one or both long edges 100s₁, 100s₂ can be at a substantially lower temperature from the pre-heated region. This temperature variation may vary depending on the casing, packaging machine, and location/configuration of the at least one pre-heater, for example. By way of example only, and not intended to be limiting to the scope of the invention. it is contemplated that the lower temperature may be 10% or more lower, e.g., between about ambient and less than about 120 degrees F., but other temperature differences are possible.

The casing 100 can be a multi-layer film comprising at least two different materials.

Referring to FIG. 5, the at least one pre-heater 50 can be a single pre-heater that directs heat primarily or solely to one long side of the casing 100s₂. At least one pre-heater 50 can reside at a location that is laterally offset from an axially extending centerline C/L of the horn 20, shown as the left side of the axially extending centerline C/L of the horn 20 which is associated with the lower layer 100b of the long edge of the film or casing.

In some embodiments, the at least one pre-heater 50 can reside anywhere along the forming collar 30 at an axial location d2 that is over the horn proximate the forming collar, typically before the forming collar forces the film/casing into a tubular casing. The target zone 101 to be preheated to a temperature close to, but under, the melting point of the casing 100.

FIG. 5 also illustrates that at least one heater 50 can reside within an axial distance d1 from a rear end portion of the belts 45b and/or the heat-seal heater 40. The d1 distance can vary. At least one pre-heater 50 can reside proximate the forming collar over a shoulder (s) 30s and a distance d1 of the belts 45b and/or heat-seal heater. In some embodiments, it is contemplated that d1 can be between about 2 inches to about 24 inches, such as about 2 inches, about 3 inches, about 4 inches, about 5 inches, about 6 inches, about 7 inches, about 8 inches, about 9 inches, about 10 inches, about 11 inches, about 12 inches, about 13 inches, about 14 inches, about 15 inches, about 16 inches, about 17 inches, about 18 inches, about 19 inches, about 20 inches, about 21 inches, about 22 inches, about 23 inches, and about 24 inches.

Optionally, in some embodiments, the primary portion of the casing 100 (at least the portion away from the long side edge portions) is substantially unheated by the at least one pre-heater 50 proximate the forming collar 30 so that the temperature of the primary body of the casing remains close to a temperature that would have occurred without use of the pre-heater proximate the forming collar.

As shown in FIGS. 1-6, the at least one pre-heater 50 can include a pre-heater 50 that resides above the horn 20 and/or forming collar 30. The at least one pre-heater 50 can be configured to project or emit heat downward.

In some embodiments, the at least one pre-heater 50 can be oriented to extend in a different (non-vertical) orientation, e.g., to extend inwardly downward or upward toward the forming collar 30, rather than directly above.

The forming collar 30 can also be held in a different orientation from that shown in FIGS. 1-6, e.g., rotated to direct the flat casing long edges 100s₁, 100s₂ together along an outer side or the bottom with the heat seal heater 40 residing to the side or under the horn 20, respectively. Thus, where the forming collar 30 has these configurations, the pre-heater 50 can be oriented to complement the respective orientation, e.g., when the joint 101j is reside below the horn/forming collar 20, 30 the pre-heater 50 can be directed to project heat upwardly.

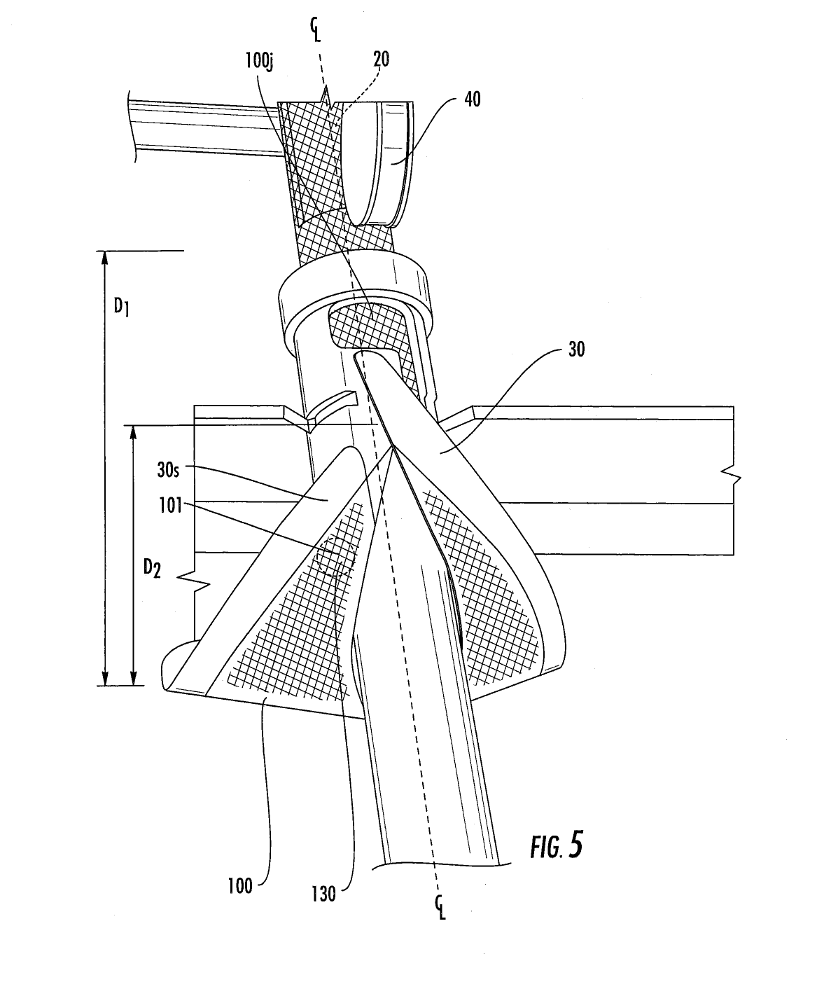

FIG. 6 illustrates that the at least one pre-heater 50 can be configured to project or emit heat about a localized target zone 101 on the forming collar 30.

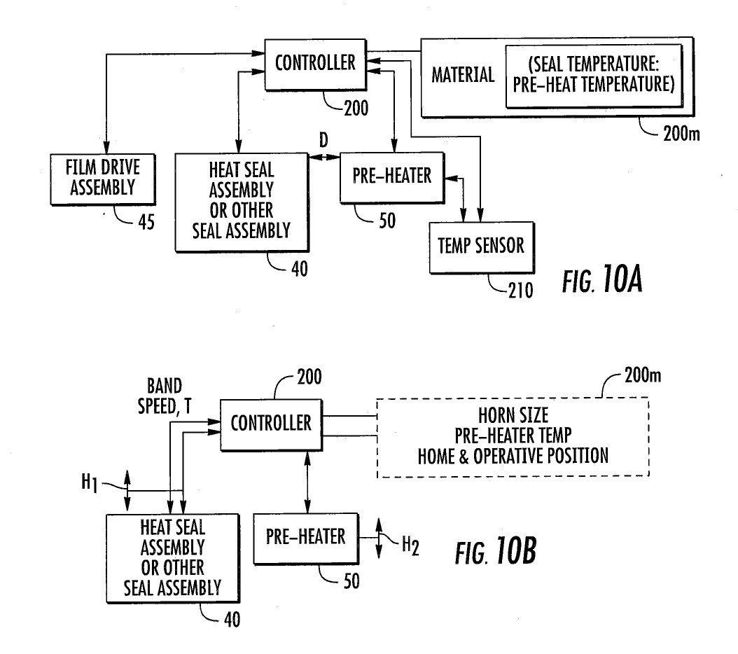

As shown by the lateral and vertical arrows in FIG. 6, the apparatus 10 can include a pre-heater assembly 55 that is configured to allow lateral adjustment (“L”), axial adjustment (“A”) and height adjustment (“H”). The adjustments can be manual, at least for “initial” set-up for respective various size forming collars 30 and horns 20. In some embodiments, at least the height translation “H” between home and operative positions is automated and directed by a controller 200 (FIGS. 10A/10B) in communication with the pre-heater assembly 55 (typically using an electric or pneumatic actuator) to be able to move the pre-heater 50 up and down. Thus, when the machine or apparatus 10 is “OFF”, the pre-heater 50 can be retracted to a home position.

The controller 200 can direct the pre-heater 50 to travel to a home position away from the horn 20 and forming collar 30 to an active position during operation. The active position can be within about 0.25 inches to about 3 inches of (above in the embodiment shown) the forming collar 30 as shown, for example, in FIG. 3. In some embodiments, the pre-heater 50 can be electronically directed to the home position when the machine 10 and/or pre-heater 50 is turned “off” to remove the heat source from the casing material or machine 10. In some particular embodiments, the distance between home and ON positions can be between about 2-24 inches, typically between about 3-12 inches.

The pre-heater 50 can be any type pre-heater that can provide the desired heat to increase the temperature of at least one long end 100s₁, 100s₂ of the casing to a defined temperature or temperature range including conductive or convection heaters. The at least one pre-heater 50 proximate the forming collar 30 is typically an electric heater. The at least one pre-heater 50 can comprise one or more of infrared heaters, resistive heaters, ceramic heaters, heat lamps, and laser heaters, with or without forced fluid hot fluid spray output and the like. The at least one pre-heater 50 can employ a plurality of different heater types.

In some embodiments, the pre-heater 50 can be configured to spray heated fluid such as a gas or liquid to pre-heat the film. The heated fluid can comprise liquid that is sprayed at a sufficiently high temperature to vaporize on contact with the casing or in the air prior to contact with the casing.

In some embodiments, the pre-heater 50 can comprise a heat gun configured to blow hot compressed gas toward the forming collar 30. The pre-heater 50 can be rated at any suitable wattage, including, for example, between about 100 W-4000 W, such as about 1000 W, about 1500 W, about 2000 W and about 3500 W.

The apparatus 10 can include at least one sensor 210 (FIGS. 10A/10B), typically a temperature sensor such as a thermocouple or other sensor to provide a measurement of temperature associated with the pre-heater 50. In some embodiments, at least one of the at least one sensor 210 is a temperature sensor onboard the heater assembly 55. In some embodiments, at least one of the at least one sensor 210 is a temperature sensor that can be held by the forming collar 30, typically proximate the collar target zone 130. In some embodiments, at least one of the at least one sensor 210 can comprise a temperatures sensor held by the apparatus 10 to reside in-line with an outlet 51 of the pre-heater 50 when in the operational position during active operation. The sensor 210 can be configured to translate with the pre-heater 50 or can be statically or moveably held by the apparatus 10 and placed in operative position during active pre-heat operation of the pre-heater 50.

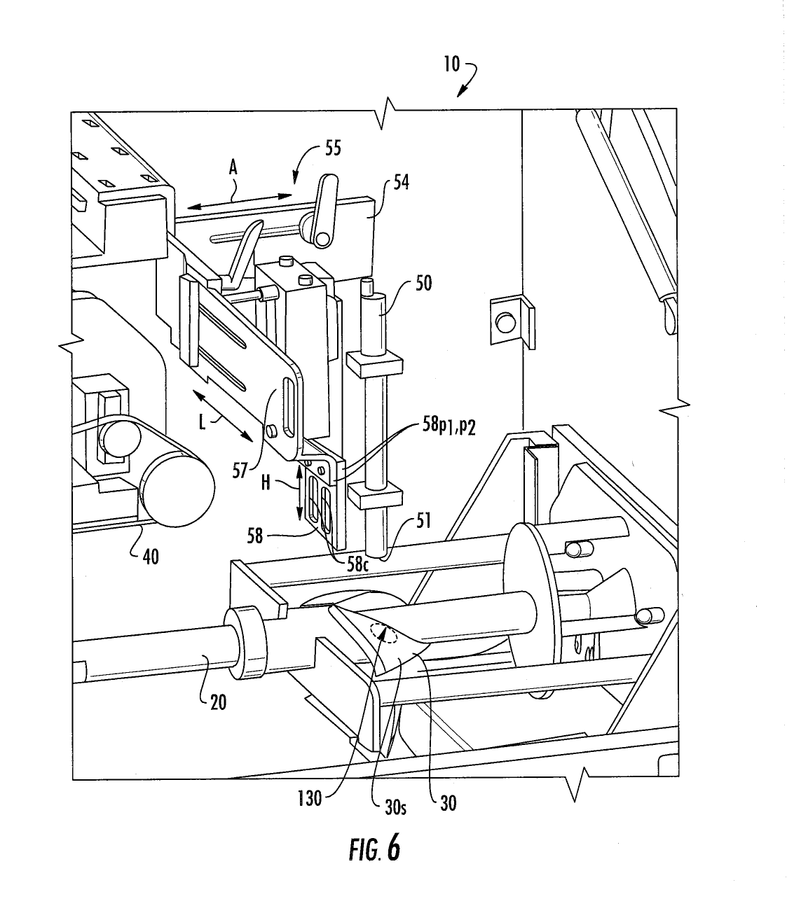

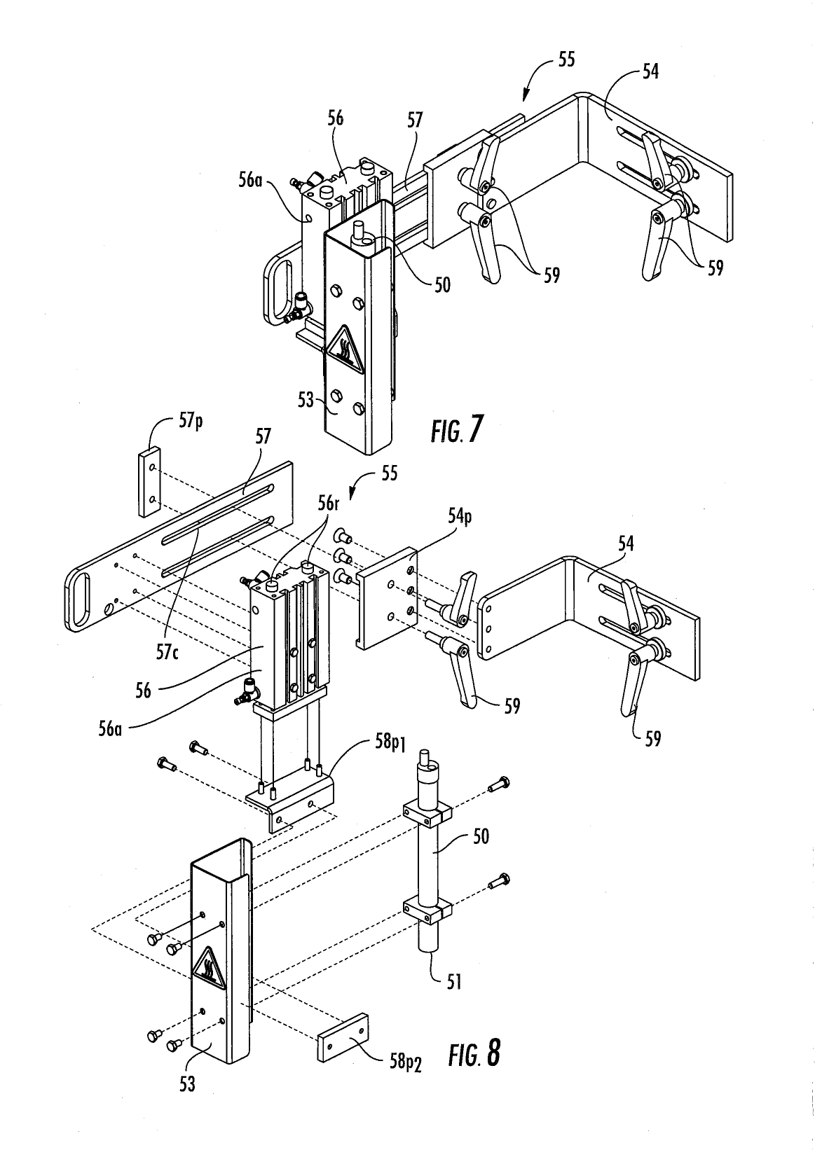

FIGS. 7-9A, and 9B illustrate an exemplary pre-heater assembly 55. The pre-heater 50 can be held inside a shield or guard 53. The pre-heater assembly 55 can include cooperating brackets 57, 54. The assembly 55 also includes locking members 59 that engage plates 57p and 54p on opposing sides of locking channels 57c to allow axial and lateral movement of the pre-heater 50 so as to accommodate different size forming collars 30 and chutes 20 in the apparatus 10.

The assembly 55 can also include an extension subassembly 56, such as an actuator 56 that can be held by the laterally extending bracket 57. The actuator 56a can be an electric actuator or a pneumatic actuator with a cylinder and rod 56r. The extension (and retraction) subassembly 56 can move the pre-heater 50 up and down. The extension subassembly 56 can alternately comprise a mechanical linkage, cam, gear or rail-based mechanism to carry out the translation. The pre-heater assembly 55 can direct the extension subassembly 56 to extend the pre-heater 50 so that the end 51 extends outside the guard 53 during pre-heating.

In some embodiments, the axially extending bracket 54 can include channels 54c with locking members 59 that engage the frame or apparatus internal mounting member to allow for axial position adjustment.

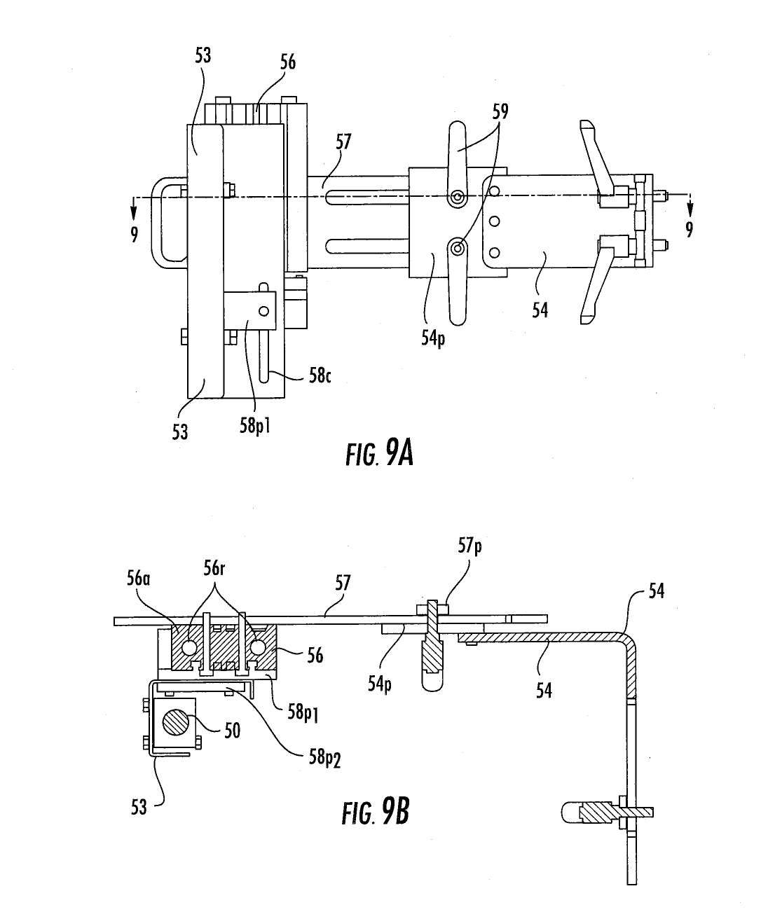

As shown in FIGS. 6 and 9A, the shield 53 can include at least one downwardly extending channel 58c. The assembly 55 can include cooperating plates 58p₁, 58p₂ on opposing sides of the at least one channel 58c to slidably move the pre-heater 50 up and down as directed by the actuator 56.

The forming collar 30 can comprise a heat (thermally) conductive material to facilitate heating both sides of the material.

As shown in FIGS. 10A and 10B, the apparatus 10 can include or be in communication with a controller 200. The controller 200 is in communication with the heat-seal assembly 40 and the at least one pre-heater 50. The controller 200 can be held in an HMI (Human Machine Interface) with a display of menu options allowing a user to select: (a) a size forming collar/horn or diameter casing and/or (b) film material type. The controller 200 can have predefined operational modes with film drive speed, pre-heater positional data for correct positioning and an operational temperature for the pre-heater 50 and the like. Table 1 provides an example of different parameters that may be predefined and programmed in the controller (e.g., as an electronic library or look-up chart) for automated operation for different film types and/or horn sizes (e.g., different film tubular diameters and forming collars).

TABLE 1

| | Tubular | | | |
|---|---|---|---|---|
| Film | Casing/forming | Heat Band | Pre-Heater | |
| Type/thickness/ | collar and/or | Seal | Position and | Film Drive |
| Manufacturer | Horn Size | Position | Temp. | Speed |
| F1 | T1 | H1 | PH1 | D1 |
| F2 | T2 | H2 | PH2 | D2 |
| F3 | T3 | H3 | PH3 | D3 |

The controller 200 can be configured as or be in communication with a proportional-integral-derivative controller (PID controller) to have a control loop feedback mechanism for varying power output to the pre-heater 50 to maintain the heat output by the pre-heater 50 to generate a substantially constant heated temperature of the target zone 130 on the forming collar 30 and/or corresponding film zone 101 for a consistent heat-seal.

In some embodiments, the pre-heater 50, when in operative position, is configured so that only the target zone 101 is heated to within a controlled temperature range (on average) over a single batch or roll of flat stock film.

Different casing materials can have different heat and seal parameters. Examples of the different parameters include a coefficient of thermal expansion, heat seal temperature, heat band contact pressure and/or time, heat band speed, heat-band temperature and/or length and the like. Also, different target products or emulsions may impact the heat-seal operation.

FIG. 10A illustrates that at least one pre-heater 50 can be within a distance d1 of the start of the heat band or other heater 40 as discussed above with respect to FIG. 5.

FIG. 10A illustrates that the controller 200 can include or be in communication with a module 200m that defines for a plurality of different casing or film materials, a seal temperature for the heat seal assembly 40 along with a corresponding pre-heat temperature for the pre-heater 50 so that the heat-seal and pre-heat temperatures can vary depending on the target casing material. The pre-heater 50 can be configured so that the temperature of at least one of the long edges of the casing rearward of but proximate the heat-seal heater 40 and/or as the casing exits the forming collar 30 is elevated to be less than the melting point.

In some embodiments, it is contemplated that the heating may be carried out to heat the material to be within about 25 degrees F. of the melting point of the casing material. In some embodiments, it is contemplated that the target region 101 can be heated to be within about 10-20 degrees F. of the melting point of the casing or even within 5-10 degrees F. of the melting point of the casing for some materials.

FIG. 10B illustrates that controller 200 can direct the height positioning relative to the horn 20 and forming collar 30, shown as distances H1 and H2, respectively, of the heat seal heater 40 and the pre-heater 50 via respective actuators or other drive systems. FIG. 10B also illustrates that the controller 200 can include or be in communication with a module 200m with menu options to allow a user to select a product, film type or other input to have the machine 10 select defined corresponding operational parameters such as an operative position of the at least one pre-heater 50 proximate the forming collar and pre-heater output to generate a desired elevated temperature.

As shown in FIG. 11, the apparatus 10 can include more than one pre-heater 50. It will be appreciated that FIG. 11 is shown by way of example and the machine can include one or more of the noted pre-heaters 50. Where more than one pre-heater 50 is used, the different pre-heaters 50a-50d can be staged to pre-heat the casing to different (typically increasing) temperatures so that the last pre-heater 50d raises the temperature to a temperature close to but under the melting point of the casing 100. FIG. 11 illustrates that pre-heater 50a can be configured as a warming oven. Pre-heater 50b can project heat inwardly toward the flat casing (film) 100 as it passes the pre-heater 50b. The pre-heater 50c is angled to project heat over a top of the forming collar 30. The pre-heater 50d can be configured to project heat down over the forming collar 30.

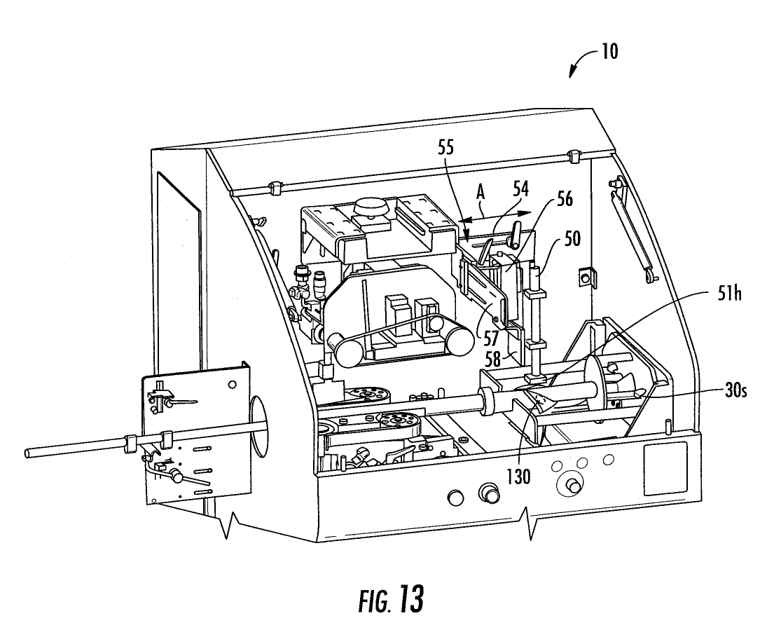

FIG. 12 illustrates that the pre-heater 50′ can be held on the forming collar, typically as a resistive heater directly on the forming collar 30. The pre-heater 50′ can reside on a lower surface of the shoulder 30s of the forming collar. The pre-heater 50′ can be on one side of the forming collar 30. The pre-heater 50′ can be on both upper sides of the forming collar 30 and may heat to different temperatures or to the same pre-heat temperature.

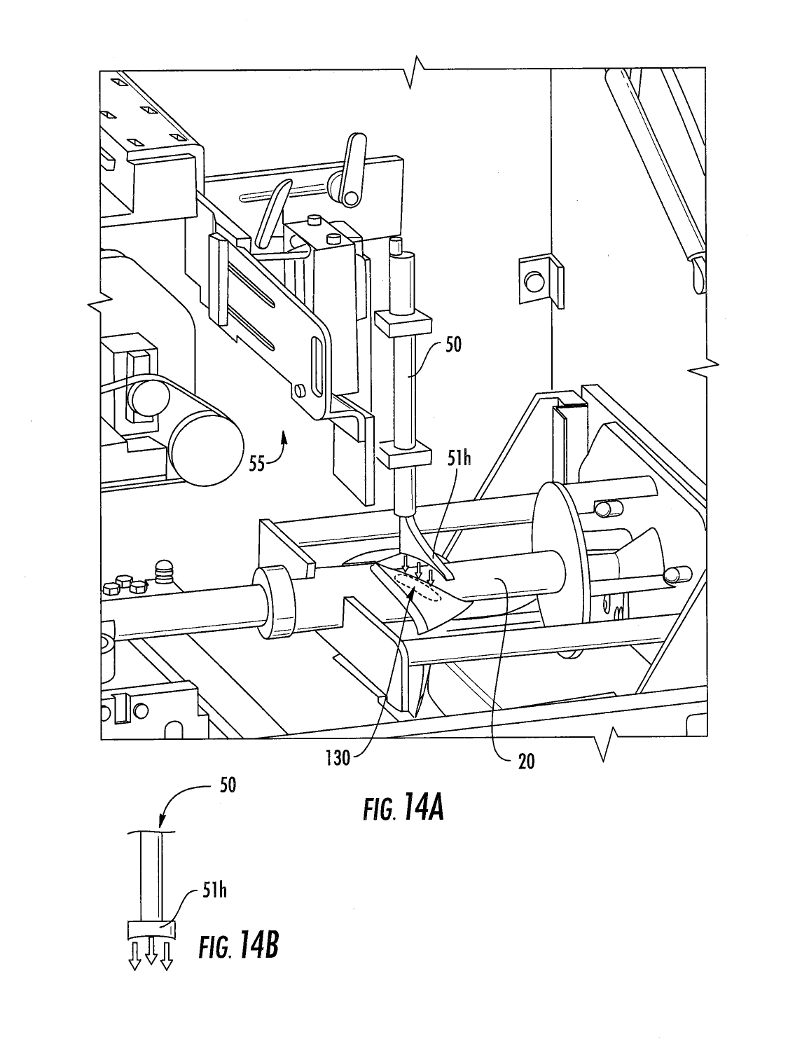

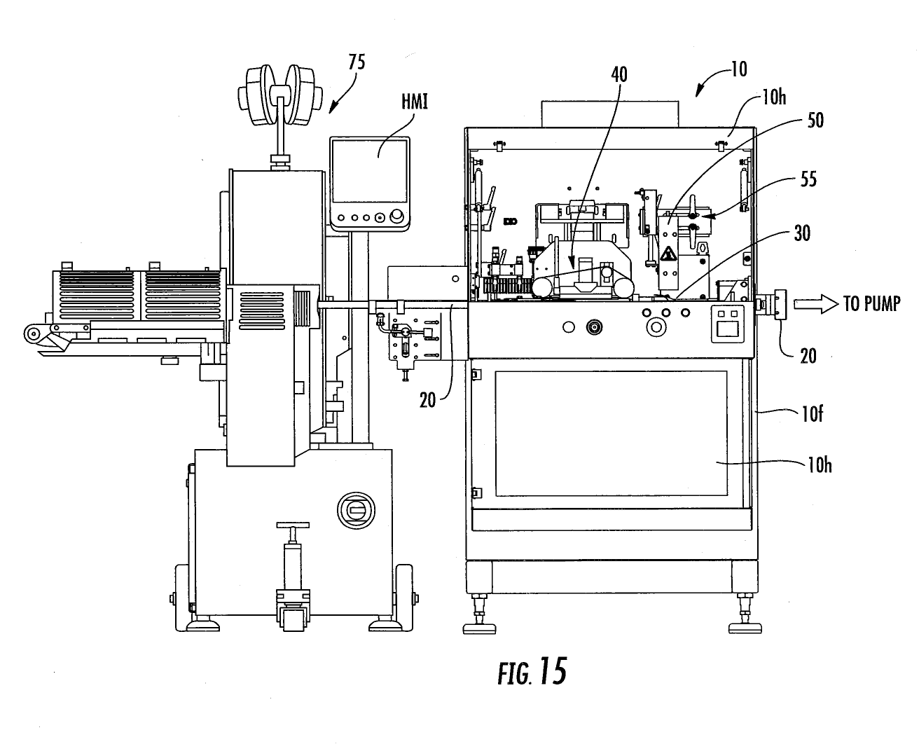

FIGS. 13, 14A and 14B illustrate that the lower end 51 of the pre-heater 50 can have a shaped head 51h rather than be circular as shown in FIGS. 1-6, for example. The shaped head 51h can extend laterally and/or axially or longitudinally. The shaped head 51h can have a planar lower end or may have a curved (e.g., arcuate) shape (FIGS. 14A, 14B). The shaped head 51 can be positioned to be proximate to but laterally offset from the axially extending centerline of the horn C/L over the forming collar 30.

The pre-heating can be configured to direct at least one pre-heater 50 to pre-heat at least one long side edge of casing at a location on or proximate the forming collar 30, typically a distance of between about 1-4 inches from a rear end of a heat band seal assembly 40, to a defined elevated temperature. In some embodiments, a single long side 100s₂ is preheated to an elevated temperature by the at least one pre-heater 50. In other embodiments, both long sides 100s₁, 100s₂ are preheated proximate the forming collar 30. The long edge associated with the bottom layer 100b of the seal/joint 100j may be heated to a temperature above the long edge associated with the upper layer 100u.

The pre-heater 50, 50′ can be configured to allow machines to operate faster with increased speed of the heat-seal downstream of the pre-heater 50, 50′ and/or provide a more reliable seal irrespective of factory temperature conditions.

The apparatus 10 can form part of a packaging system that includes a shirred voiding/clipping apparatus located downstream of a respective horn and heat seal assembly 40 to produce an elongated product. The product can be produced in a linked chain of tubular or chub product with clips applied at desired intervals. The length and diameter of each link, chub or discrete product and/or the overall length of the chain can vary depending on the type of product being produced. Examples of typical strand or chain lengths are between about 1-6 feet. See, e.g., U.S. Pat. Nos. 3,543,378, 5,167,567, 5,067,313, and 5,181,302, the contents of which are hereby incorporated by reference as if recited in full herein.

The apparatus 10 can be configured to interchangeably accommodate different size horns 20 and corresponding different size forming collars 30 that form the suitable size casing. For example, the diameters of the horns 20 can range between about ¼ inch to about 8 inches, typically between ¾ inches to about 5 inches in defined size increments of ¼ inch, ½ inch or 1 inch, for example. The forming collar 30 will have a width that is larger than the corresponding horn and typically has about a 3× width as the corresponding diameter of the tubular casing.

The horn 20 can be configured as internal and external cooperating horns. For example, the internal horn can have a length that extends through an external heat seal horn 20h (FIG. 9). The heat seal horn 20h resides at least under the heat seal assembly 40. The horn 20 may be a single horn that can have a different external shape at the forming collar and/or heat seal assembly 40, such as a flat surface aligned with the heat seal band to facilitate heat seal operation.

FIG. 15 illustrates that the machine 10 can cooperate with and/or include an automated or semi-automated clipper 75. The horn 20 can be in fluid communication with a filler/product pump and supply located upstream thereof. As the flowable product, “pasty” or other product, exits the discharge end of the horn 20, it is stuffed into or fills the heat-sealed tubular casing material that is held around the outer surface of the horn 20. One or more clips can be applied by the clipper 75 to seal the ends of the tubular package. The horn 20 can be positioned in the apparatus 10 on support structures 10f so that it is substantially horizontal with the centerline aligned with upstream and downstream components during operation. The forming collar 30 resides over the horn 20 (or another horn upstream of the heat-seal horn) that guides and/or shapes roll stock (not shown) to substantially conform to the shape of the tubular horn as the material travels away from the forming collar 30 and hence wrap the elastomeric or other desired casing material around the horn 20.

Examples of exemplary devices and apparatus used to void, clip or tension casing material are described in U.S. Pat. Nos. 4,847,953; 4,675,945; 5,074,386; 5,167,567; and 6,401,885, the contents of which are hereby incorporated by reference as if recited in full herein. Generally stated, clips can be applied to the casing material to wrap around and close or seal the product therein. The seal formed by the clip against the casing may be sufficiently strong so as to be able to hold a vacuum of about 16 mm Hg for about 24-48 hours. Examples of suitable clips include metallic generally “U”-shaped clips available from Tipper Tie, Inc., in Apex, N.C. Other clips, clip materials and clip configurations may also be used.

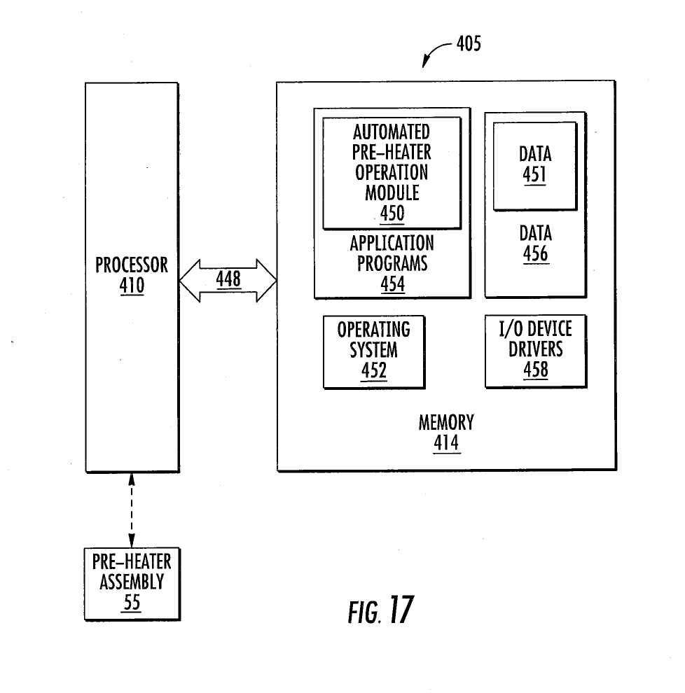

FIG. 16 illustrates a method of steps or actions that can be used to carry out embodiments of the present invention. Flat roll stock casing material can be pulled through a forming collar to form a shaped (typically tubular) casing (block 250). The flat roll stock is pre-heated as the casing material travels through the forming collar (block 260). Long edges of the casing material are sealed together after the pre-heating (block 270).

The pre-heating can be carried out to locally heating only one or both long edges of the flat roll stock as the casing travels over an outer shoulder(s) (block 261).

The pre-heating can be carried out to heat a target localized region on a single long edge of casing (block 263).

The pre-heating can comprise pre-heating a target region or regions of the casing to have a temperature below the melt point but within 25 degrees F. of the melt point as it exits the forming collar (block 265).

The method can include providing a pre-heater above a forming collar to carry out at least some of the pre-heating (block 266).

The casing can be formed into a tubular shaped casing and the method can include applying at least one clip to at least one end portion(s) of the sealed casing (block 274).

The sealing can be carried out using a rotating heat-band seal (block 272).

The pre-heating can be carried out so that the casing has an elevated temperature that is under the melt point of the casing but within 25 degrees F. of the melting point as it enters a heat zone defined by the heat seal band.

The pre-heating can include pre-heating at least one long edge of the casing as it travels over a shoulder associated with the forming collar within about 0.1 second to about 1 second prior to applying a heat seal band heater to the preheated surface of the casing.

FIG. 17 is a block diagram of exemplary embodiments of data processing systems 405 in accordance with embodiments of the present invention. The processor 410 communicates with the memory 414 via an address/data bus 448. The processor 410 can be any commercially available or custom microprocessor. The memory 414 is representative of the overall hierarchy of memory devices containing the software and data used to implement the functionality of the data processing system 405. The memory 414 can be non-transitory, and can include, but is not limited to, the following types of devices: cache, ROM, PROM, EPROM, EEPROM, flash memory, SRAM, and DRAM.

As shown in FIG. 17, the memory 414 may include several categories of software and data used in the data processing system 405: the operating system 452; the application programs 454; the input/output (I/O) device drivers 458; an Automated Pre-Heater Operation Module 450 for directing operational temperature, and position of one or more pre-heaters, the position can be defined relative to the casing and/or horn type in use; and the data 456.

The data 456 may include a look-up chart of different casing run times (i.e., for tubular elastomeric (polymer) casings formed in situ, as well as the product, filling rates, selectable chain lengths and link lengths and the like 451 corresponding to particular or target products for one or more producers.

As will be appreciated by those of skill in the art, the operating system 452 may be any operating system suitable for use with a data processing system, such as OS/2, AIX, DOS, OS/390 or System390 from International Business Machines Corporation, Armonk, N.Y., Windows CE, Windows NT, Windows95, Windows98 or Windows2000 from Microsoft Corporation, Redmond, Wash., Unix or Linux or FreeBSD, Palm OS from Palm, Inc., Mac OS from Apple Computer, LabView, or proprietary operating systems. The I/O device drivers 458 typically include software routines accessed through the operating system 452 by the application programs 454 to communicate with devices such as I/O data port(s), data storage 456 and certain memory 414 components and/or the dispensing system 420. The application programs 454 are illustrative of the programs that implement the various features of the data processing system 405 and preferably include at least one application which supports operations according to embodiments of the present invention. Finally, the data 456 represents the static and dynamic data used by the application programs 454, the operating system 452, the I/O device drivers 458, and other software programs that may reside in the memory 414.

While the present invention is illustrated, for example, with reference to the Module 450 being an application program in FIG. 17, as will be appreciated by those of skill in the art, other configurations may also be utilized while still benefiting from the teachings of the present invention. For example, the Module 450 may also be incorporated into the operating system 452, the I/O device drivers 458 or other such logical division of the data processing system 405. Thus, the present invention should not be construed as limited to the configuration of FIG. 17, which is intended to encompass any configuration capable of carrying out the operations described herein.

The I/O data port can be used to transfer information between the data processing system 405 or another computer system or a network (e.g., the Internet) or to other devices controlled or directed by the processor 410. These components may be conventional components such as those used in many conventional data processing systems which may be configured in accordance with the present invention to operate as described herein.

For example, the data processing system 405 can be a computer program product with computer readable program code configured to provide a plurality of different predetermined operational modes. In particular embodiments, the computer readable program code is configured to accept user input to identify the type of casing material selected for deployment and/or a selection of the size of the horn or tubular casing. In addition, the computer readable program code can be configured to inhibit operation until the door of the machine is closed.

In addition, the computer readable program code can be configured to automatically identify when a casing supply is exhausted. For example, the computer readable program code can be configured to monitor and/or detect when a limit switch is triggered responsive to force applied to a lead attached to a trailing edge portion of the supply of casing material as the trailing edge portion of the casing material advances.

While the present invention is illustrated, for example, with reference to particular divisions of programs, functions and memories, the present invention should not be construed as limited to such logical divisions. Thus, the present invention should not be construed as limited to the configuration of FIG. 17 but is intended to encompass any configuration capable of carrying out the operations described herein.

The operation and sequence of events can be controlled by a programmable logic controller. The operational mode can be selected by an operator input using a Human Machine Interface to communicate with the controller as is well known to those of skill in the art.

The flowcharts and block diagrams of certain of the figures herein illustrate the architecture, functionality, and operation of possible implementations of selective implementation of single and dual clip closure means according to the present invention. In this regard, each block in the flow charts or block diagrams represents a module, segment, or portion of code, which comprises one or more executable instructions for implementing the specified logical function(s). It should also be noted that in some alternative implementations, the functions noted in the blocks may occur out of the order noted in the figures. For example, two blocks shown in succession may in fact be executed substantially concurrently or the blocks may sometimes be executed in the reverse order, depending upon the functionality involved.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clauses, where used, are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. A method for sealing flat roll stock into shaped casing for encasing target products, comprising:
pulling casing from a roll of flat stock through a forming collar to form a shaped casing;
pre-heating the casing as the casing travels through the forming collar; and
sealing long edge portions of the casing together after the pre-heating.

2. The method of claim 1, wherein the pre-heating is carried out so that one or both long edge portions of the casing has an elevated temperature that is under a melt point of the casing but within about 25 degrees F. of the melt point as the casing approaches or resides under or over a heat seal band for the sealing.

3. The method of claim 1, wherein the pre-heating comprises pre-heating at least one long edge portion of the casing as it travels over a shoulder associated with the forming collar within about 0.1 second to about 1 second prior to applying a heat seal band heater to carry out the sealing.

4. The method of claim 1, wherein the pre-heating comprises locally heating only one or only both of the long edge portions of the casing as the casing travels over outer shoulders of the forming collar.

5. The method of claim 1, wherein the pre-heating comprises heating a single long edge portion of the casing as the casing resides on a corresponding single shoulder of the forming collar.

6. The method of claim 1, wherein the pre-heating comprises pre-heating a target region or regions of the casing associated with one or both long edge portions of the casing so that one or both of the long edge portions have a temperature below a melt point but within about 25 degrees F. of the melt point measured when the casing exits the forming collar in a tubular shape or when the casing is under a heat-seal heater.

7. The method of claim 1, further comprising automatically extending a pre-heater to reside above and proximate the forming collar to carry out at least some of the pre-heating.

8. The method of claim 1, wherein the formed shaped casing is tubular shaped casing, and wherein the method further comprises applying at least one clip to a trailing and/or leading end portion(s) of the sealed casing.

9. The method of claim 1, wherein the sealing is carried out using a heat-band seal heater within about 0.1 second to about 1 second after the pre-heating raises a temperature of a lower layer of a joint of the casing to within about 25 degrees F. of but below, a melting point of the casing.

10. The method of claim 1, wherein the pre-heating is carried out using a plurality of spaced apart pre-heaters, wherein at least one of pre-heaters is positioned above the forming collar, so that at least a lower end thereof is laterally offset from an axially extending centerline of a horn extending through the forming collar.

11. The method of claim 1, wherein the pre-heating is carried out using a single pre-heater positioned above the forming collar, the method further comprising electronically translating the single pre-heater from a home position to a lowered heating position proximate a shoulder of the forming collar, so that at least a lower end of the pre-heater is laterally offset from an axially extending centerline of a horn extending through the forming collar.

12. The method of claim 1, wherein the pre-heating comprises directing a heat source toward a single long side edge portion of the casing at a location above the forming collar a distance of between about 1-4 inches axially away from a rearward end of a heat band seal assembly.

13. An apparatus for forming shaped casings from flat roll stock for encasing products therein, comprising:
a housing;
a forming collar residing in the housing, the forming collar configured to cooperate with a roll of flat casing material to force the flat casing material to take on a shape with long edge portions of the casing material residing proximate each other; and
at least one pre-heater held in the housing, at least one of which resides on or proximate the forming collar.

14. The apparatus of claim 13, further comprising a heat-seal heater held in the housing a distance in front of the forming collar, wherein the at least one pre-heater is configured to heat the casing material so that at least one of the long edge portions has an elevated temperature that is under a melt point of the casing material but within about 25 degrees F. of the melting point as the casing material approaches or moves under or over the heat seal heater.

15. The apparatus of claim 13, wherein the at least one pre-heater comprises at least one pre-heater sized and configured to direct heat toward one shoulder or both shoulders of the forming collar to pre-heat at least one long edge portion of the casing material as the casing material travels over a respective shoulder associated with the forming collar.

16. The apparatus of claim 15, wherein the at least one pre-heater directed toward the shoulder or shoulders of the forming collar is configured to pre-heat one or both long edge portions to an elevated temperature that is under a melt point of the casing material but within about 25 degrees F. of the melt point within about 0.1 second to about 1 second prior to when the heat-seal heater contacts the preheated long edge portion or long edge portions to heat seal a joint formed by joining the long edge portions.

17. The apparatus of claim 13, wherein the apparatus comprises one or more pre-heaters that are configured to locally heat only one or only both of the long edge portions as the casing travels over outer shoulders of the forming collar.

18. The apparatus of claim 13, wherein the at least one pre-heater is a single pre-heater configured to heat a target localized region on a single long edge portion of the casing over a single shoulder of the forming collar.

19. The apparatus of claim 13, wherein the at least one pre-heater comprises at least one pre-heater held by a pre-heater assembly, the pre-heater assembly configured to hold the at least one pre-heater above the forming collar and automatically translate the at least one pre-heater between home and different operative positions, wherein the different operative positions position a lower end of the heater at different vertical distances to accommodate different size horns and respective forming collars.

20. The apparatus of claim 14, wherein the heat-seal heater comprises a rotating heat-seal band and wherein the at least one pre-heater is configured to raise a temperature of a lower layer of a joint of the casing to within about 25 degrees F. of but below, a melting point of the casing proximate the heat-seal band heater.

21. The apparatus of claim 13, wherein at least one of the at least one pre-heaters is positioned above the forming collar so that a lower end thereof is laterally offset from an axially extending centerline of the horn and directs heat toward an exterior surface of a shoulder of the forming collar.

22. The apparatus of claim 13, wherein the at least one pre-heater residing on or proximate the forming collar comprises a first pre-heater configured to heat a single long side edge portion of the casing at a location above the forming collar a distance of between about 1-4 inches from a rearward end of a heat-seal band of the heat-seal heater.

23. The apparatus of claim 13, wherein the at least one pre-heater comprises a pre-heater held by the forming collar.

24. The apparatus of claim 13, wherein the at least one pre-heater comprises a heat gun configured to blow heated compressed gas toward the forming collar.

25. The apparatus of claim 13, further comprising at least one temperature sensor in communication with the at least one pre-heater and a controller held by or in communication with the apparatus, wherein the controller is configured to adjust power to the at least one pre-heater to control a target elevated temperature generated by the at least one pre-heater.

26. A computer program product for operating an apparatus that supplies different casing materials and different horn diameters to provide encased elongate products, the computer program product comprising:
a non-transitory computer readable storage medium having computer readable program code embodied in said medium, said computer-readable program code comprising:
computer readable program code configured to provide a plurality of different predetermined operational modes for an apparatus that releasably mounts different diameter horns and respective different size forming collars to supply different sized tubular casings from flat roll stock; and
computer readable program code configured to direct at least one pre-heater to translate between an operative position over a respective forming collar to a home position.

27. The computer program product of claim 26, further comprising computer readable program code configured to control heat output of the at least one pre-heater using temperature data from at least one temperature sensor in communication with the pre-heater.
